(19) United States
(12) Patent Application Publication
(10) Pub. No.: US 2013/0141304 A1
(43) Pub. Date: Jun. 6, 2013

(54) THREE-FEED LOW-PROFILE ANTENNA STRUCTURE OFFERING HIGH PORT-TO-PORT ISOLATION AND MULTIBAND OPERATION

(71) Applicant: SkyCross, Inc., Viera, FL (US)

(72) Inventor: Li Chen, Melbourne, FL (US)

(73) Assignee: SkyCross, Inc., Viera, FL (US)

(21) Appl. No.: 13/657,138

(22) Filed: Oct. 22, 2012

Related U.S. Application Data
(60) Provisional application No. 61/549,449, filed on Oct. 20, 2011.

(51) Int. Cl. H01Q 25/04; H01Q 21/00

(52) U.S. Cl. CPC H01Q 25/04; H01Q 21/0006
USPC 343/893; 343/700 MS

(57) ABSTRACT

A three-feed, low-profile antenna offers high port-to-port isolation and multiband operation. Applications for the antenna include, but are not limited to, USB dongle, netbook, notebook, tablet, laptop, and set-top box applications requiring 3-feed MIMO or diversity protocols.

### CROSS REFERENCE TO RELATED APPLICATION

This application claims priority from U.S. Provisional Patent Application Ser. No. 61/549,449 filed on Oct. 20, 2011 and entitled THREE-FEED LOW-PROFILE ANTENNA STRUCTURE OFFERING HIGH PORT-TO-PORT ISOLATION AND MULTIBAND OPERATION, which is hereby incorporated by reference.

### BACKGROUND

The present application relates generally to wireless communications devices and to antennas used in such devices.

Many system architectures (such as Multiple Input Multiple Output (MIMO)) and standard protocols for mobile wireless communications devices (such as 802.IIn for wireless LAN, and 3G data communications such as 802.16e (WiMAX), HSDPA, and IxEVDO require multiple antennas operating simultaneously. It is generally desirable to place the antennas as close together as possible to reduce the size of the antenna system. However, placing antennas in close proximity can lead to undesirable effects of direct coupling between antenna ports and diminished independence, or increased correlation, between the radiation patterns of the antennas.

### BRIEF SUMMARY OF DISCLOSURE

In accordance with one or more embodiments, a multi-feed, low-profile antenna structure is provided with high port-to-port isolation and multiband operation. The antenna structure includes three electrically conductive antenna sections arranged in a generally linear configuration, including a first antenna section, a second antenna section, and a common antenna section therebetween. The antenna structure includes three feedports, each connected to a different one of the three antenna sections. A first electrically conductive interconnecting element connects the first antenna section to the common antenna section, and a second electrically conductive interconnecting element connects the second antenna section to the common antenna section, such that each feedport is generally electrically isolated from other feed ports. The antenna sections and interconnecting elements form a single, substantially planar radiating structure.

### BRIEF DESCRIPTION OF THE DRAWINGS

FIGS. 1 and 2 illustrate an antenna in accordance with one or more embodiments for operation in standard 2.45 and 5 GHz WiFi bands.

FIGS. 3A, 3B, and 3C illustrate top, front, and side views respectively of the antenna.

FIGS. 4, 5, and 6 graphically illustrate simulated isolation for Ports 1, 2, and 3, respectively of the antenna.

FIG. 7 graphically illustrates simulated antenna pattern correlation for the antenna.

FIGS. 8A, B, C to FIGS. 20A, B, C graphically illustrate radiation patterns in standard coordinates for Ports 1, 2, and 3, respectively, in the antenna.

FIG. 21 illustrates an antenna in accordance with one or more alternate embodiments.

### DETAILED DESCRIPTION

The present application is directed to an antenna structure having multiple antenna ports that achieves compact size, while generally maintaining isolation and antenna independence between ports, and providing multiband operation. An antenna structure in accordance with one or more embodiments comprises a planar (or substantially planar) single structure antenna having 3 feedports that is suited for 3×3 MIMO or diversity applications. As such, it is particularly suited for use in devices such as USB dongle, notebook, netbook, tablet, and set-top box wireless devices using 3×3 801.11n WiFi transceivers.

The antenna structure comprises three antenna sections including two end sections and a common antenna section therebetween. The antenna structure is advantageously configured using an isolation method described in U.S. Pat. No. 7,688,273, incorporated by reference herein, which provides radio frequency isolation of adjacent feedports in a single antenna structure that is advantageous in applications where cross-coupling and correlation between signals present at each feedport is undesirable.

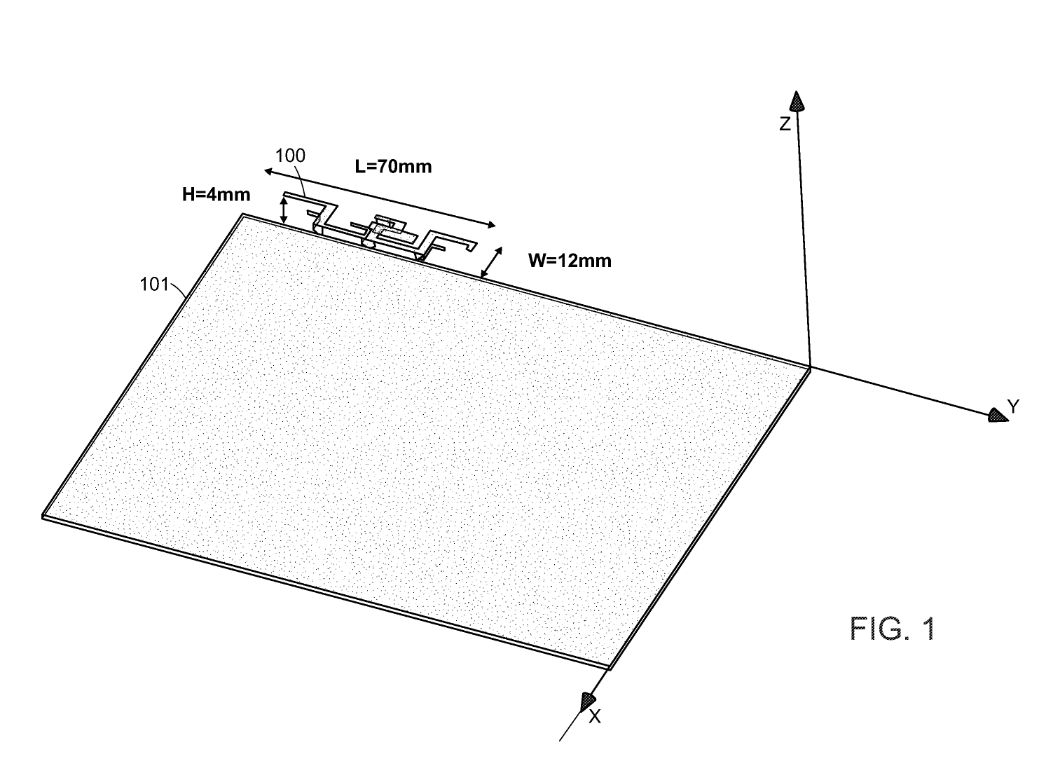

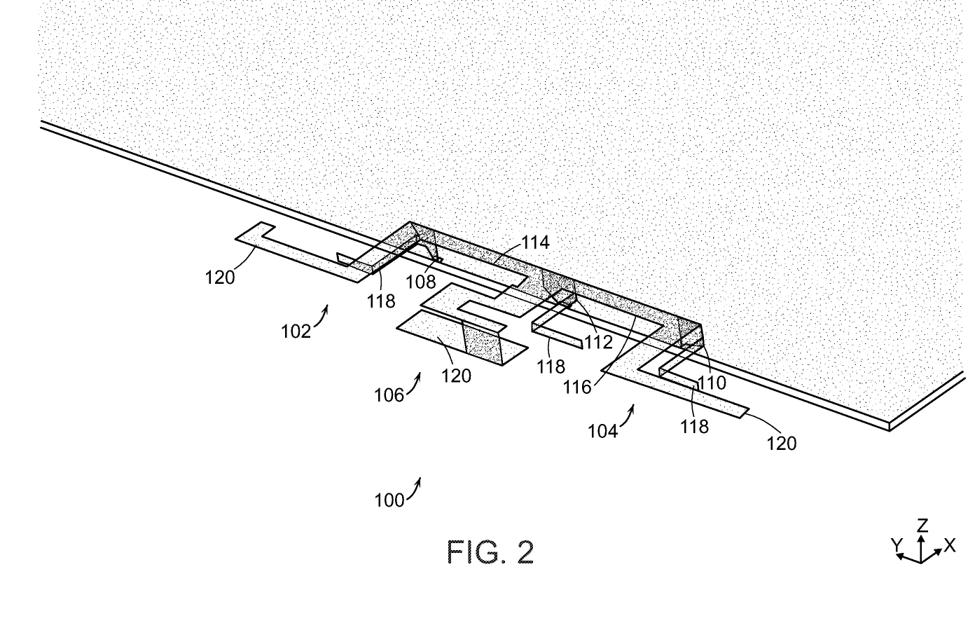

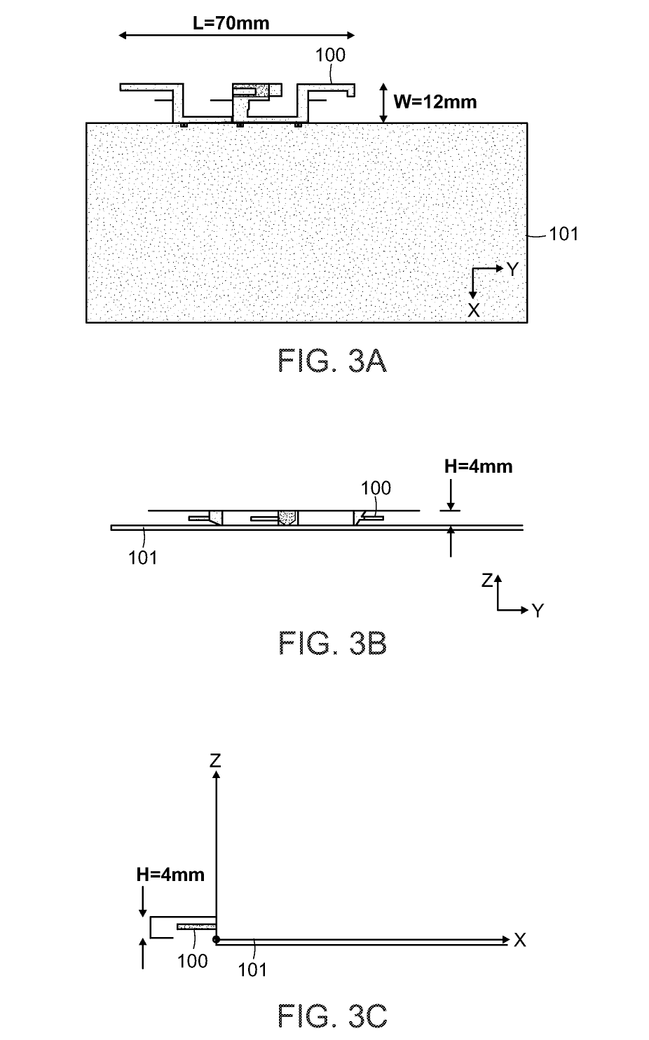

An exemplary antenna structure 100 in accordance with one or more embodiments is shown in FIGS. 1-3. The antenna structure 100 is shown mounted on a printed circuit board 101. It is a substantially planar, low profile structure, which is particularly suited for many applications having space constraints. The antenna structure 100 includes three electrically conductive antenna sections arranged in a generally linear configuration. The three sections comprise a first antenna section 102, a second antenna section 104, and a third common antenna section 106 therebetween. Each of the antenna sections is connected to a separate feedport 108, 110, 112.

The first antenna section 102 is connected to the common antenna section 106 by a first electrically conductive interconnecting element 114. Similarly, the second antenna section 104 is connected to the common antenna section 106 by a second electrically conductive interconnecting element 116. The antenna sections 102, 104, 106 and interconnecting elements 114, 116 form a single radiating structure.

Each of the antenna sections 102, 104, 106 includes a pair of branches 118, 120. In the particular implementation shown in FIGS. 1-3, the lengths of the branches have been optimized to align the frequencies of operation within the 2.4 GHz and 5 GHz WLAN (wireless local area network) bands. The upper branches 118 dictate the frequency of the upper band (5 GHz), while the lower branches 120 dictate the frequency of the lower band (2.4 GHz).

Dimensions shown in various drawings are for illustrative purposes only, and can be varied.

Excitation of the antenna 100 by applying a signal at one of the ports 108, 110, 112 will evidence a resonant condition with currents flowing on each of the antenna sections 102, 104, 106. The interconnecting elements 114, 116 however allow for currents to flow on each of the antenna sections 102, 104, 106 without passing through the feedports, thereby allowing for the ports to remain generally isolated from each other.

The interconnecting elements 114, 116 electrically connect the antenna sections 102, 104, 106 such that an antenna mode excited by one antenna port is generally electrically isolated from a mode excited by another antenna port at a given signal frequency range. In addition, the antenna patterns created by the ports exhibit well defined pattern diversity with low correlation. The interconnecting elements 114, 116 electrically connect the antenna elements such that electrical currents on one antenna element flow to adjacent antenna sections and generally bypass the adjacent feedports coupled to the other antenna sections. The electrical currents flowing through one antenna section and other adjacent antenna sections are generally equal in magnitude, such that an antenna mode excited by one feedport is generally electrically isolated from a mode excited by another adjacent feedport at a given desired signal frequency range without the use of a decoupling network connected to said antenna ports.

In the exemplary antenna 100 shown in FIGS. 1-3, the interconnecting elements 114, 116 have substantially the same length between each end antenna section 102, 104 and the common antenna section 106. The end antenna sections 102, 104 are therefore interconnected to each other by a substantially longer interconnection structure, about twice the length of each separate interconnecting element. In operation therefore, when excitation is applied to the feedport 112 connected directly to the common antenna section 106, radio frequency isolation between each end feedport 108, 110 and the common feedport 112 is provided in accordance with the same principles described above.

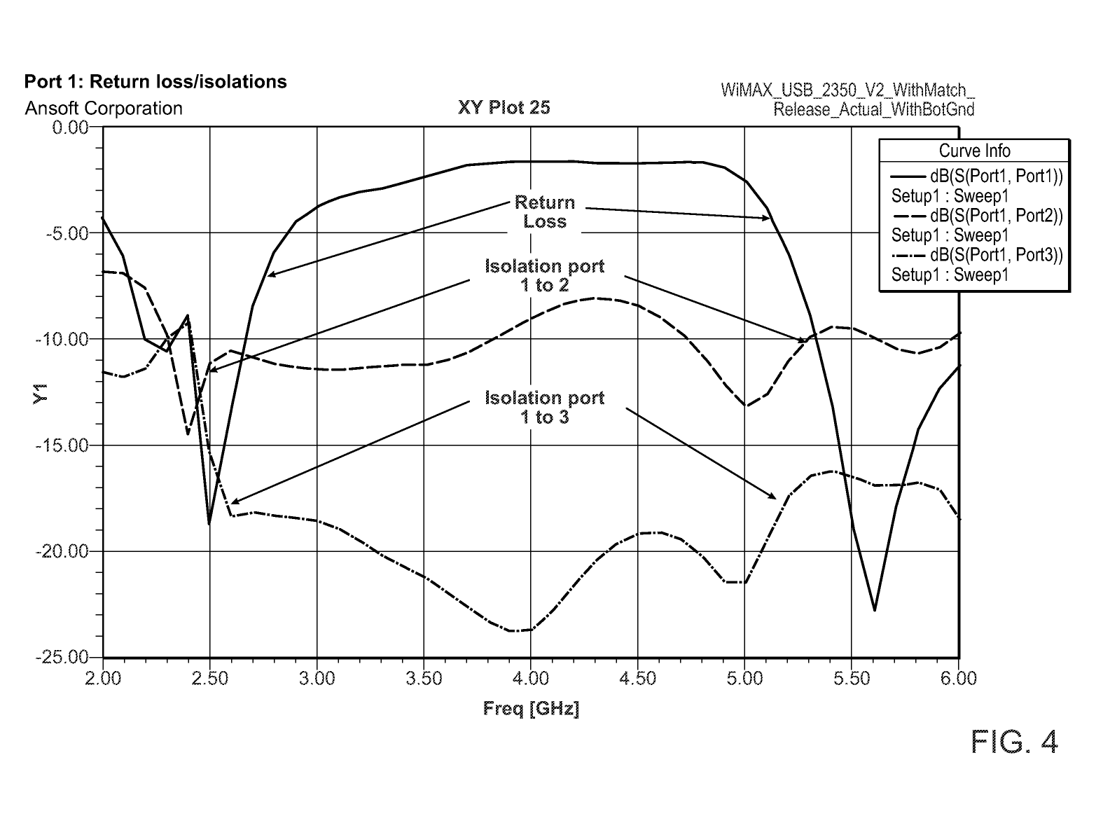

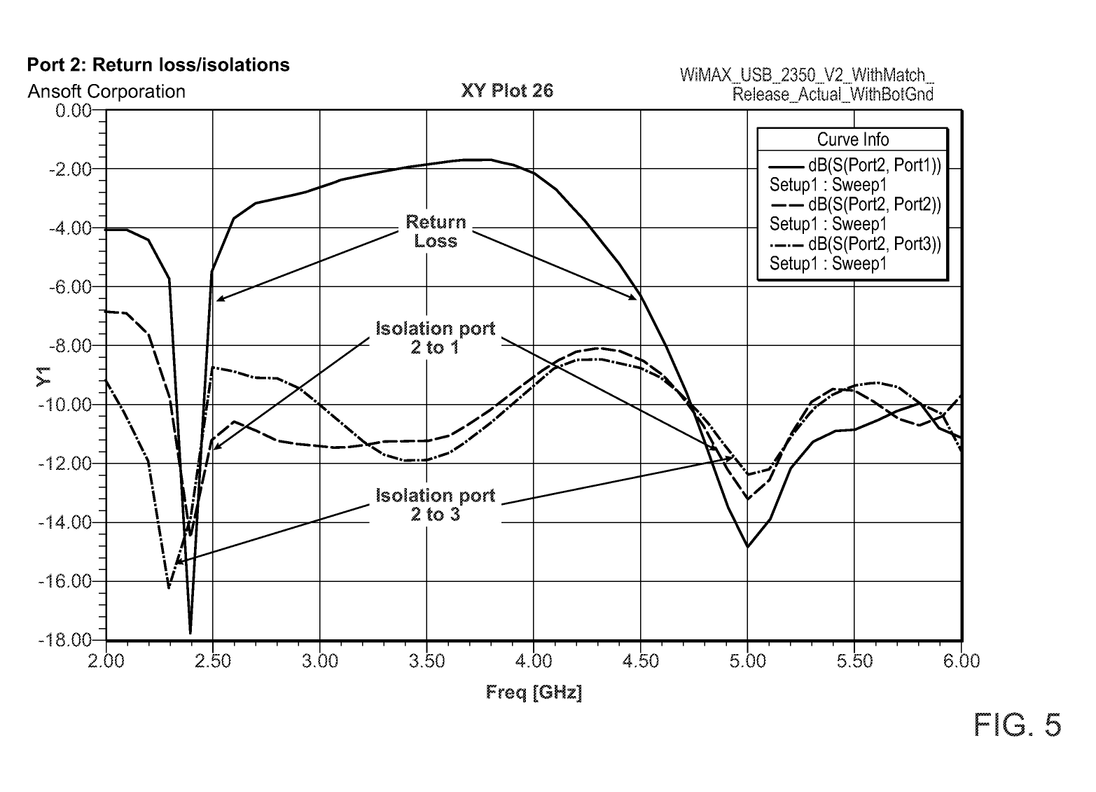

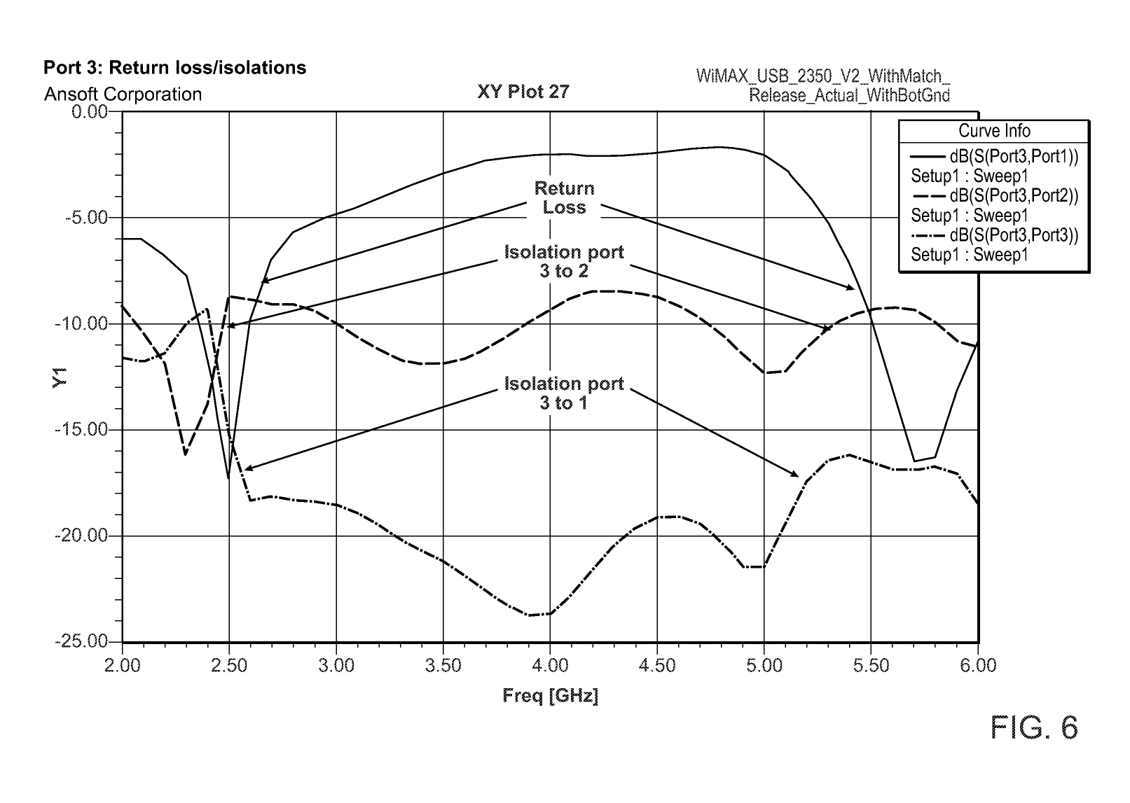

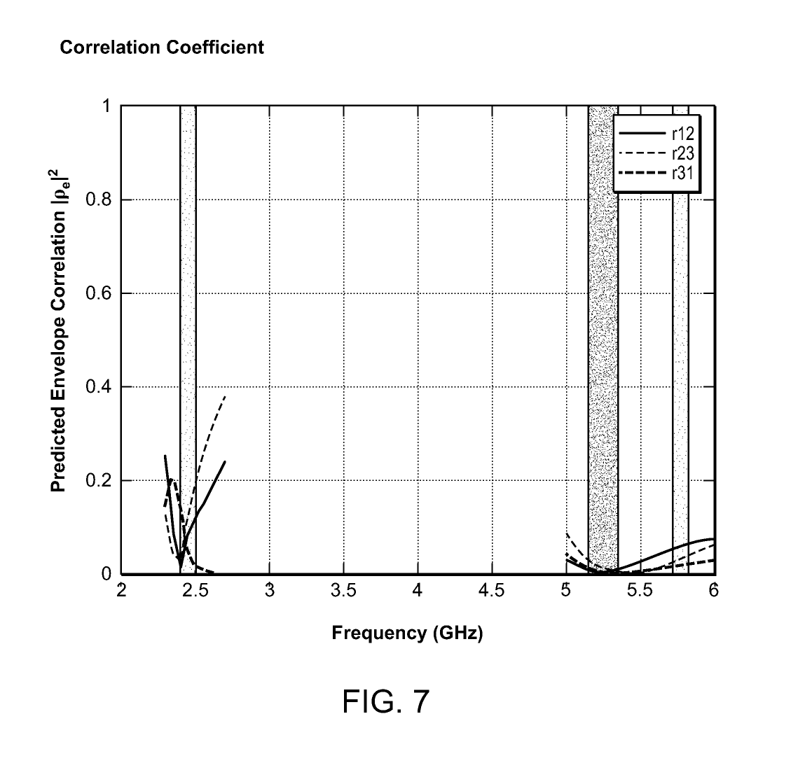

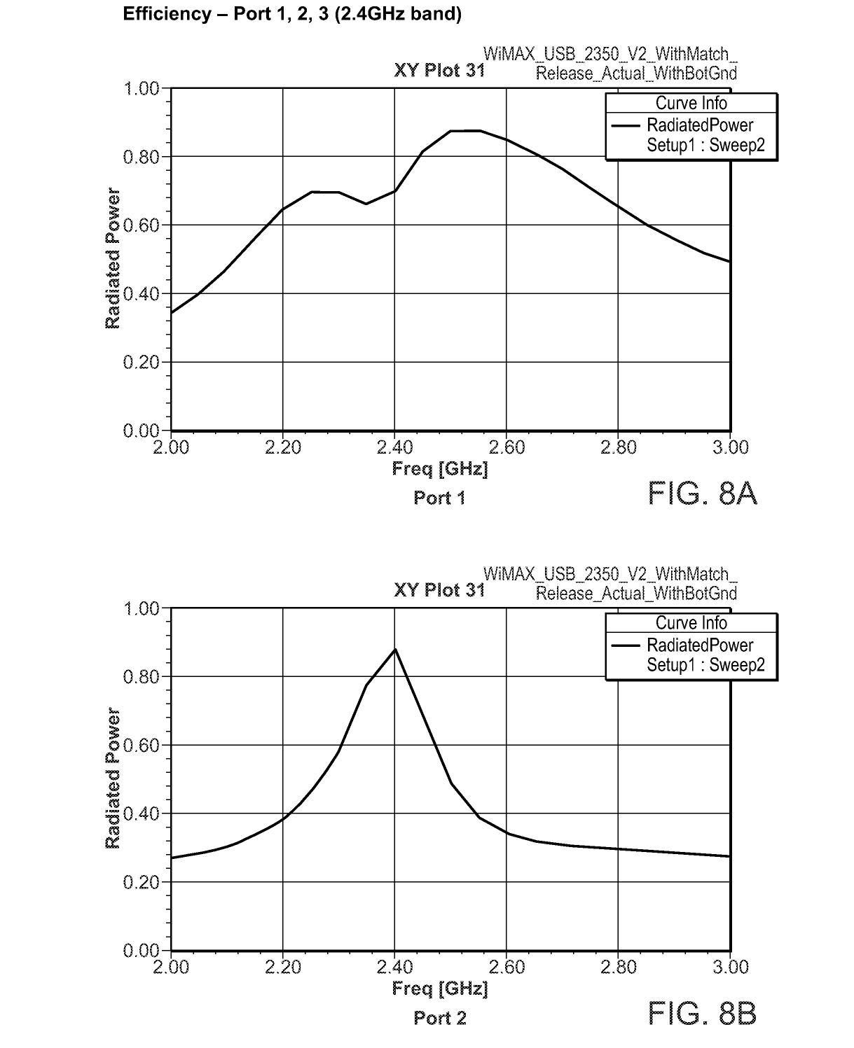

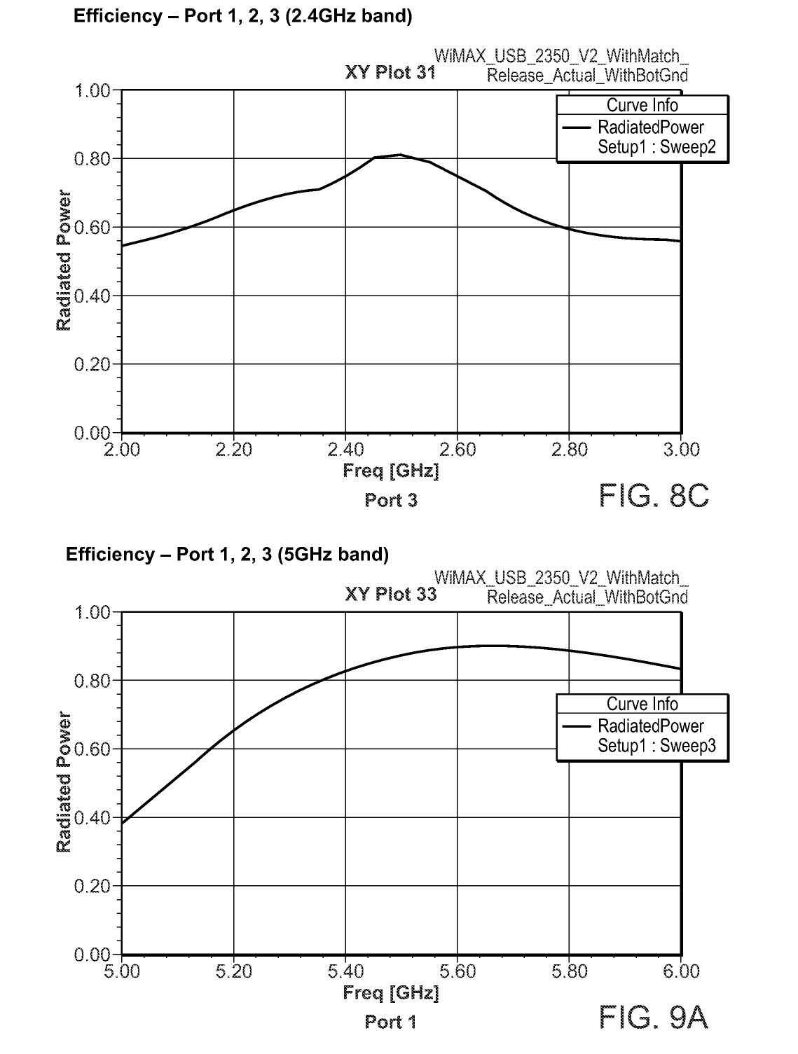

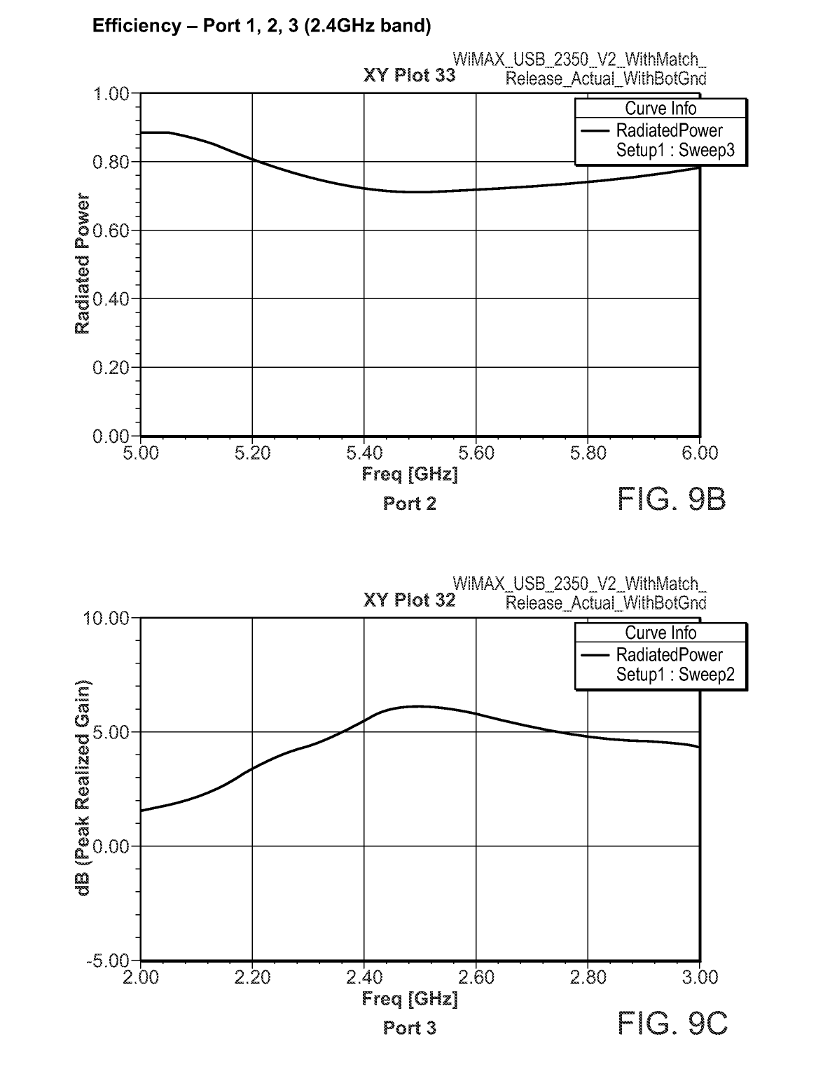

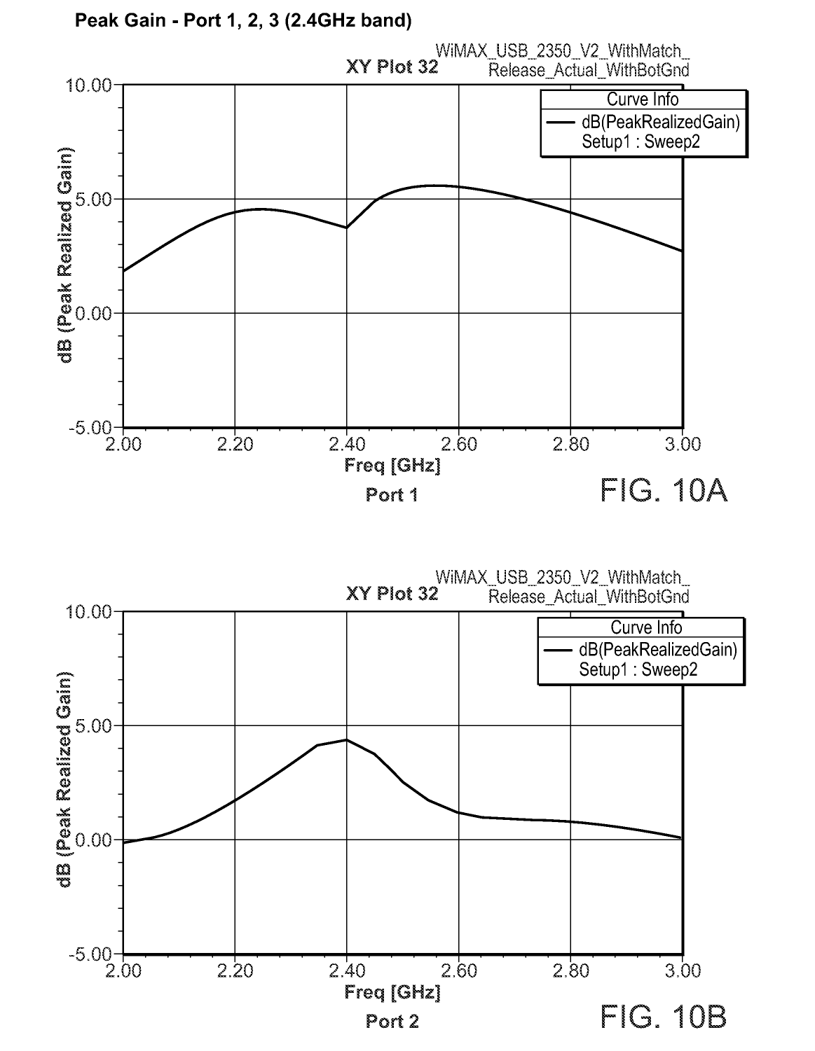

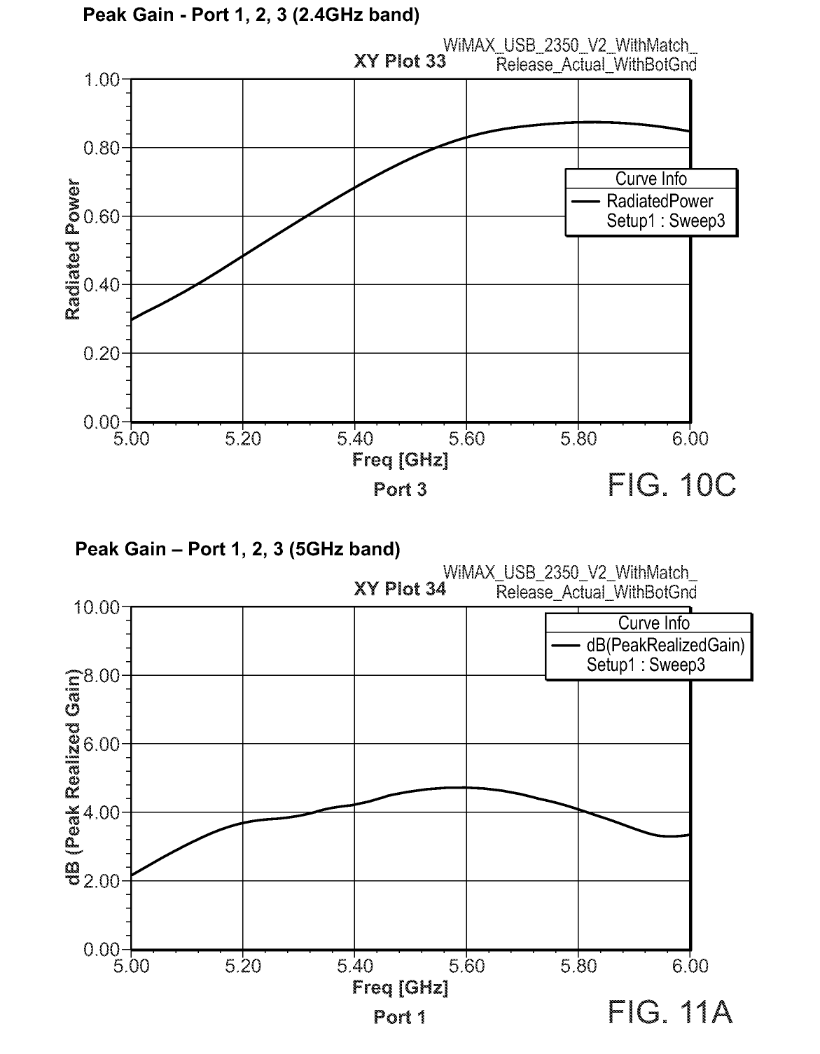

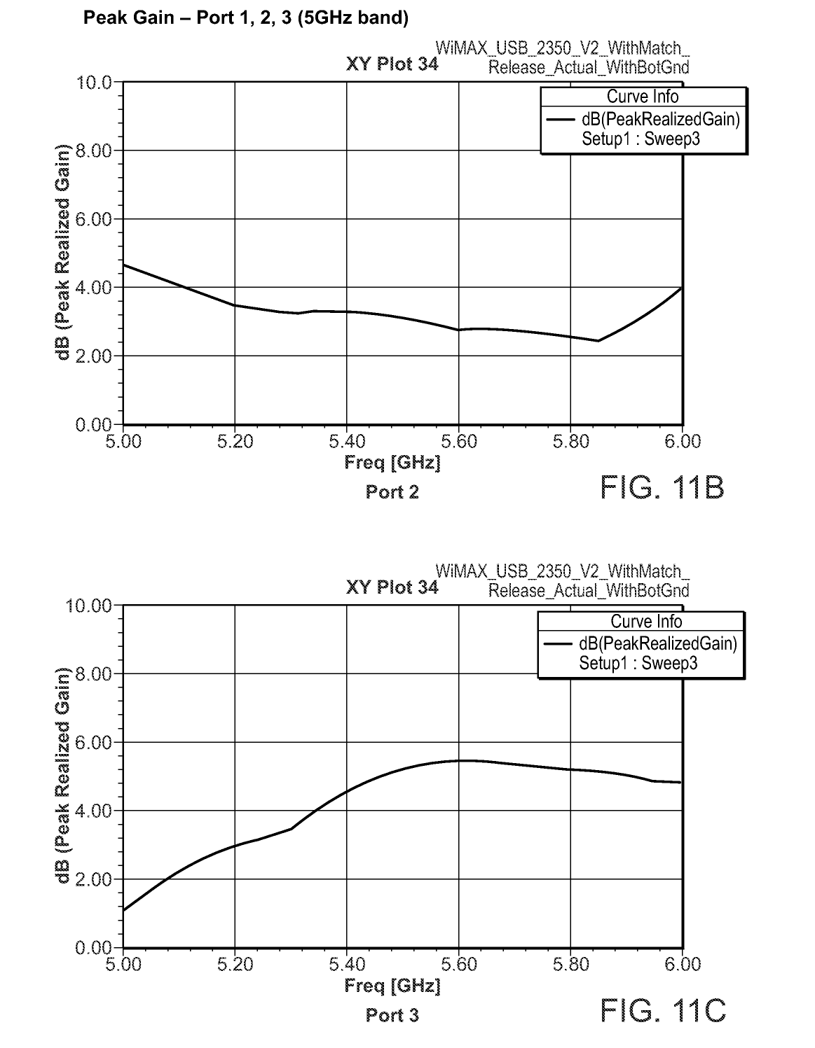

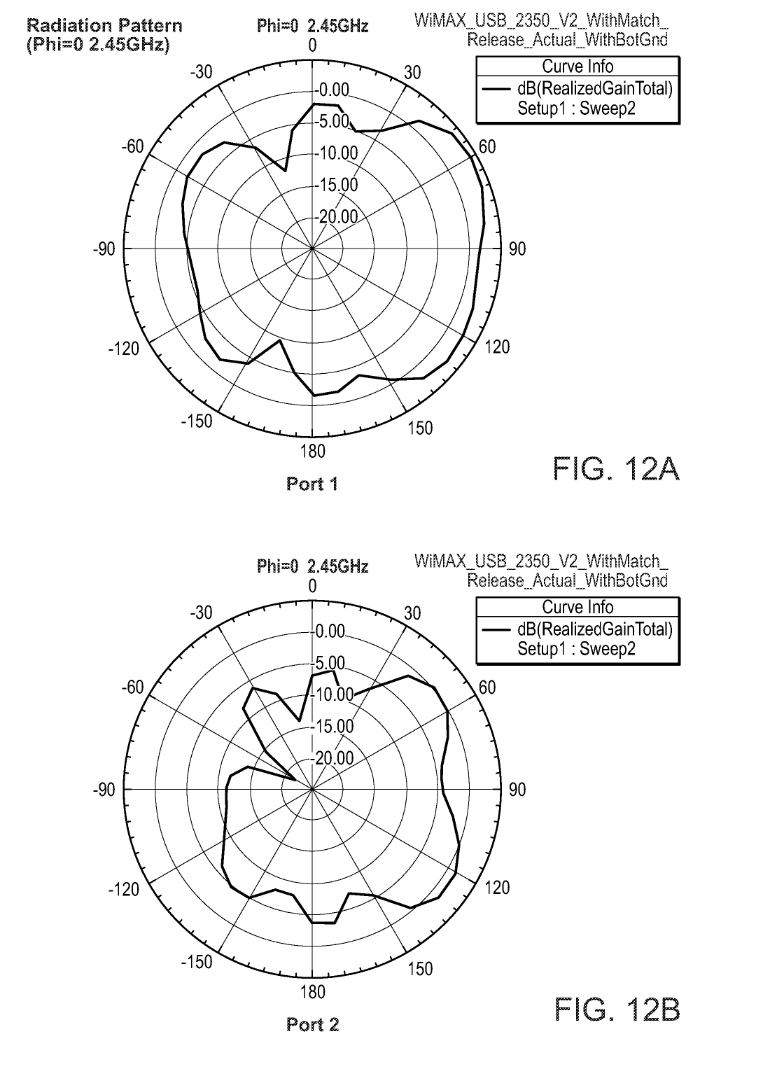

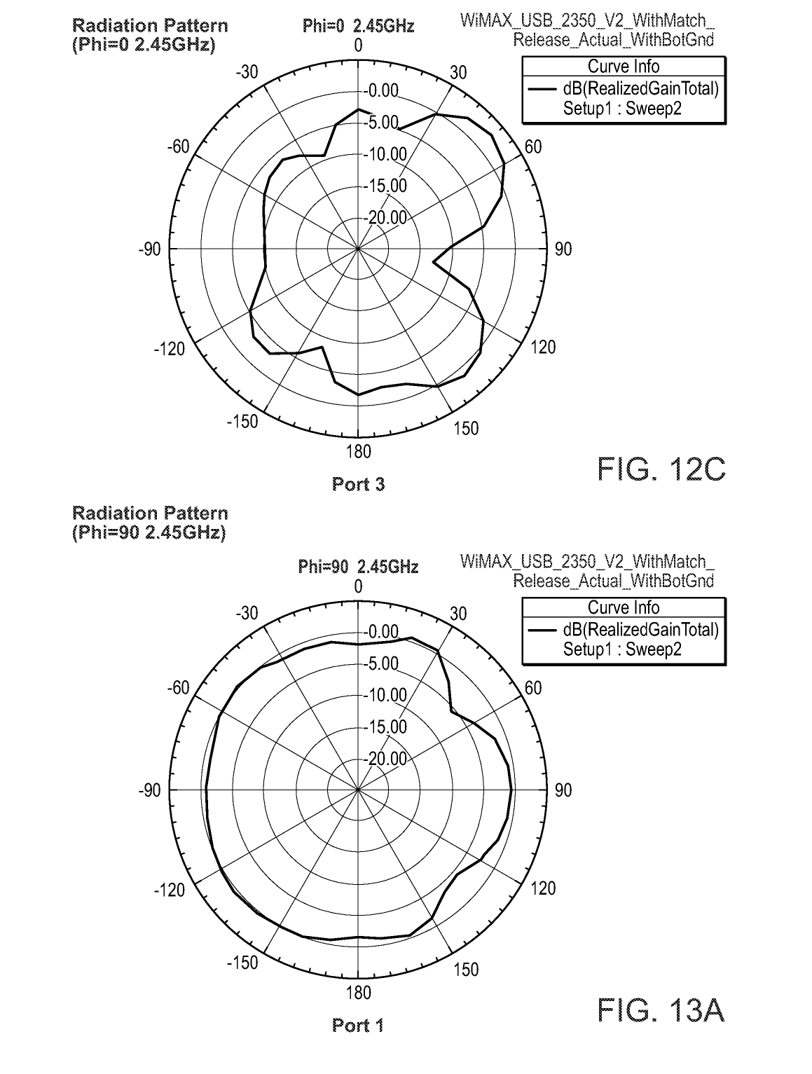

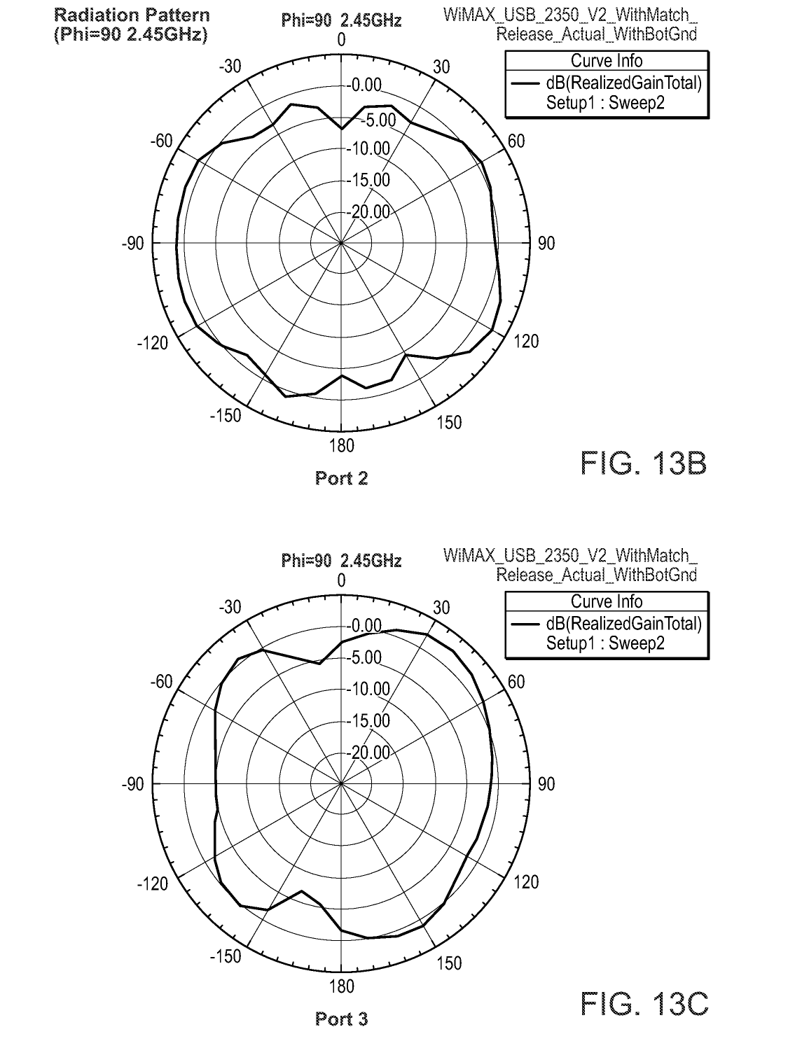

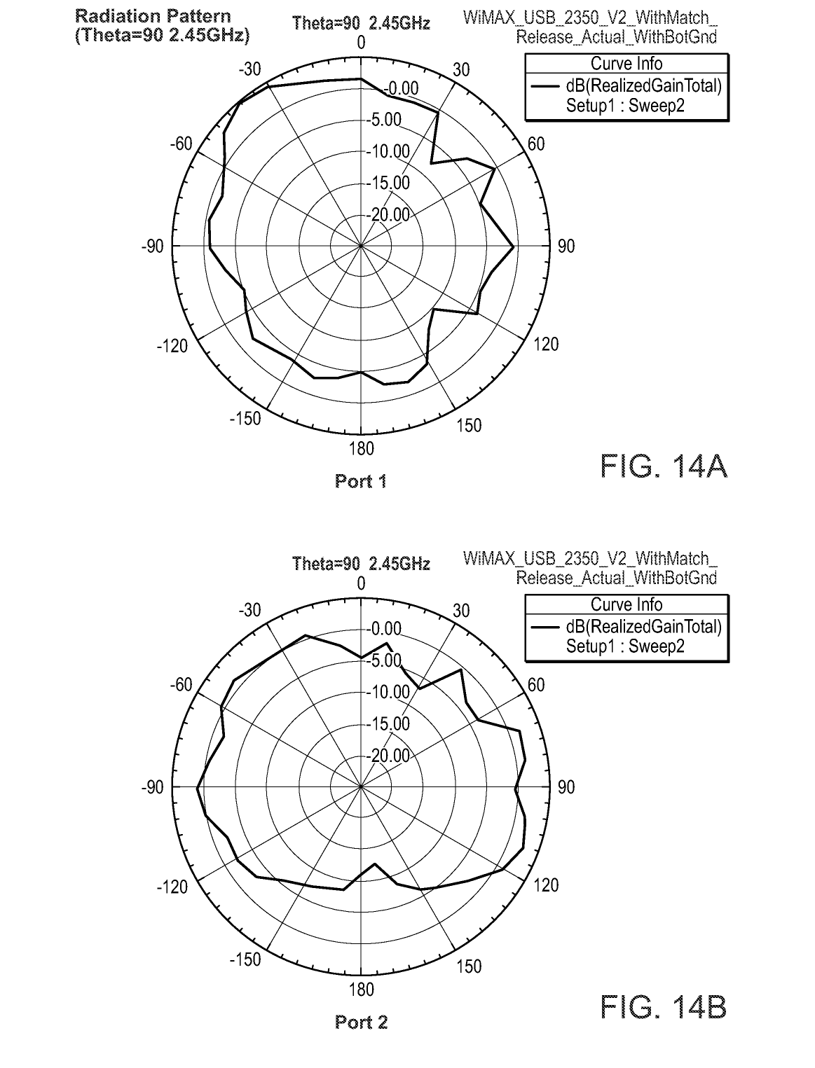

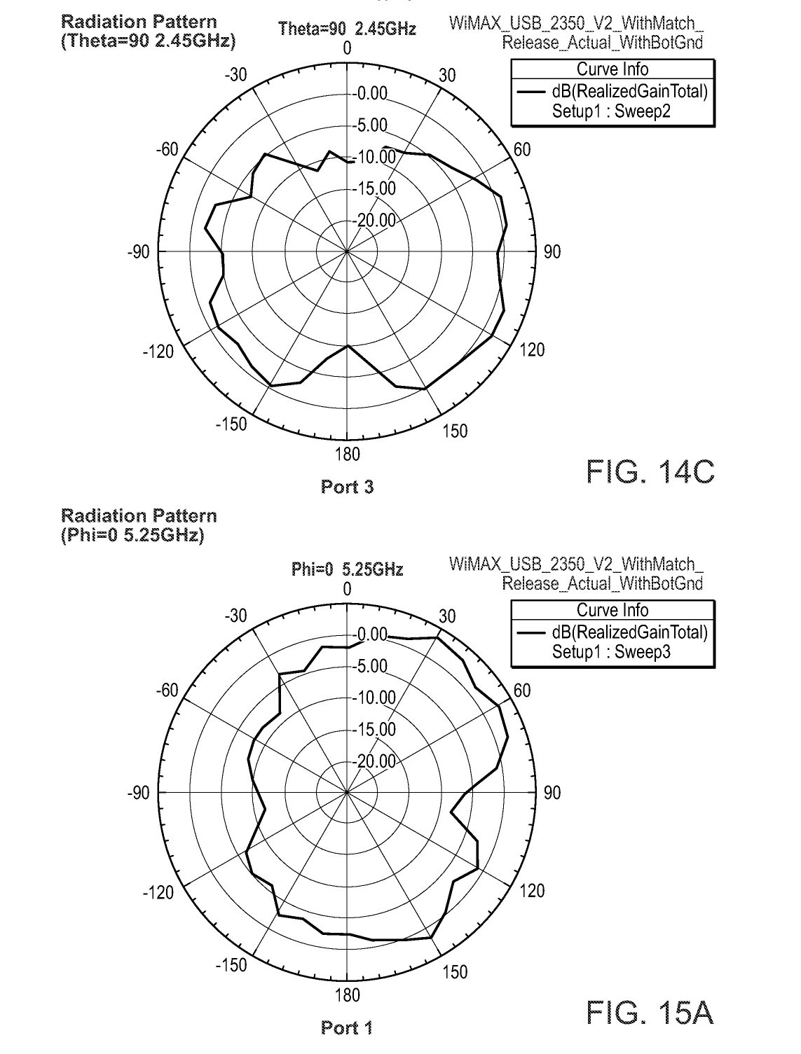

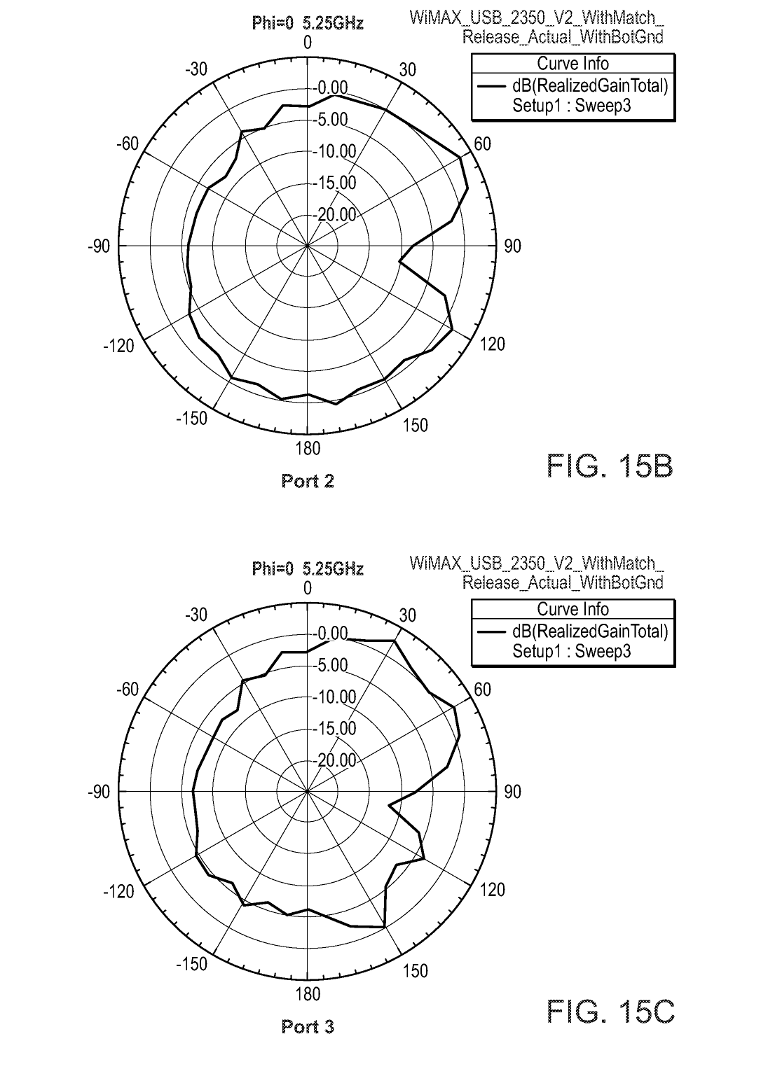

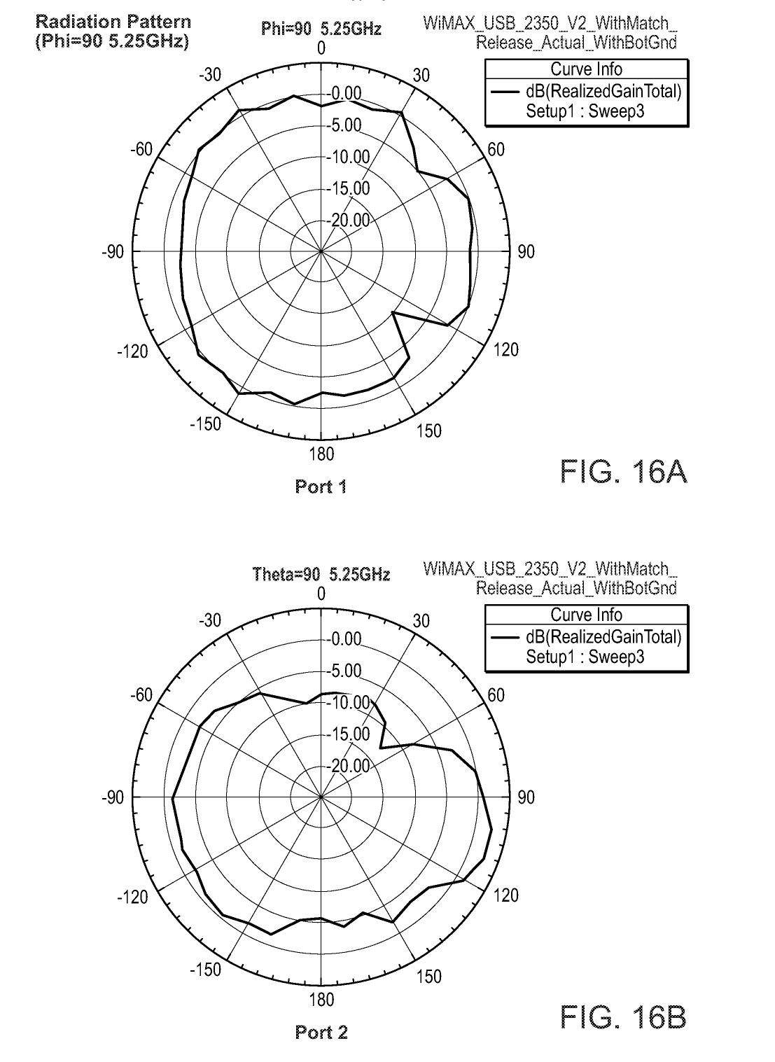

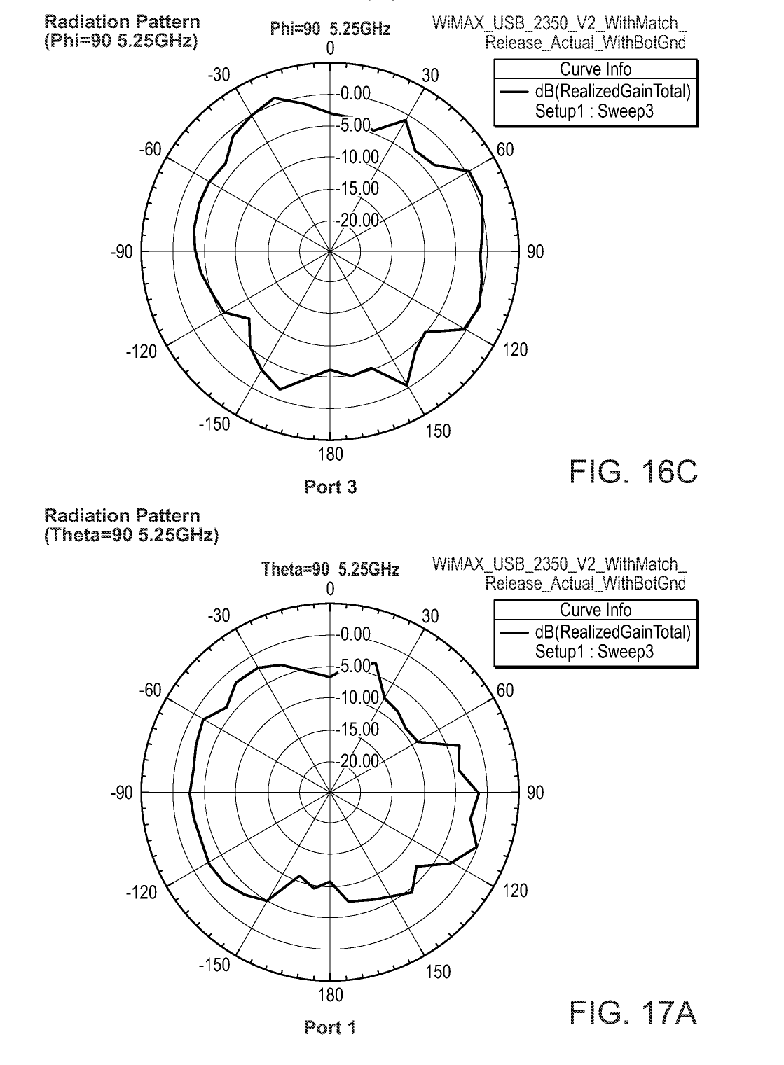

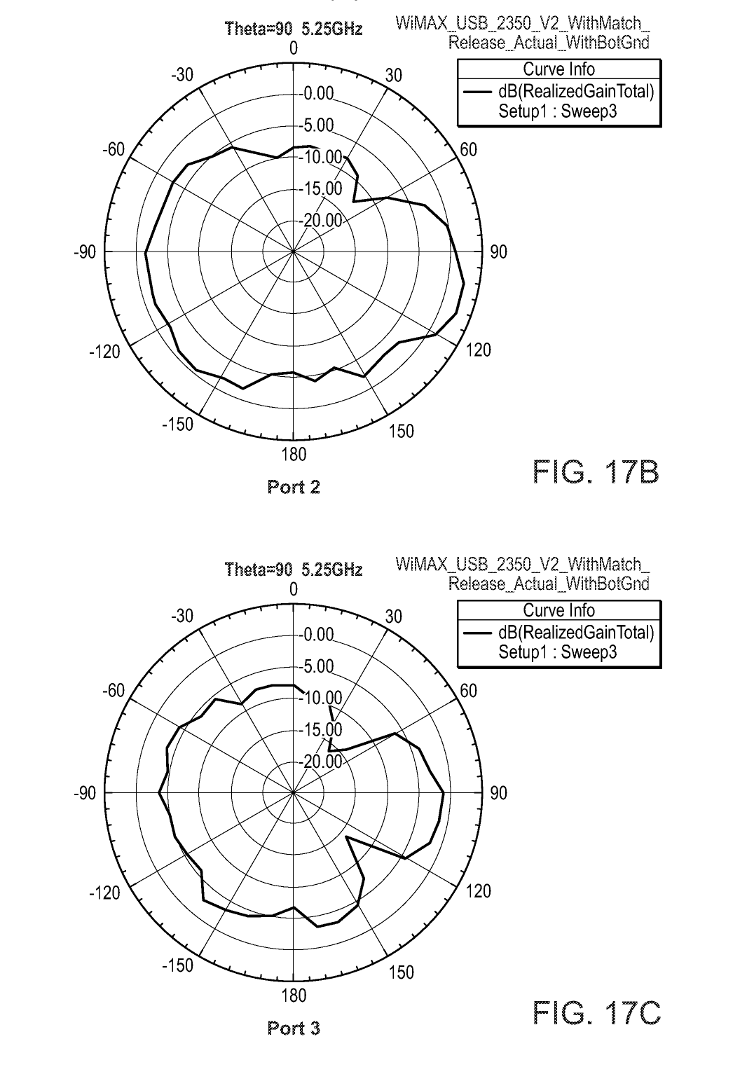

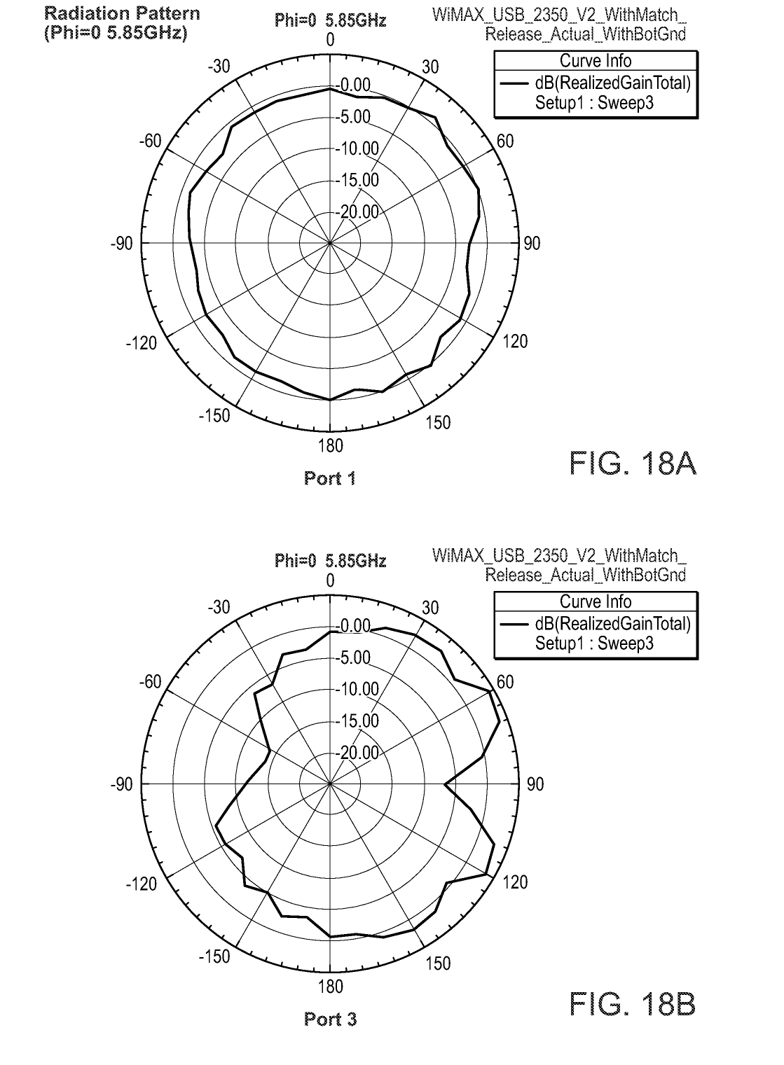

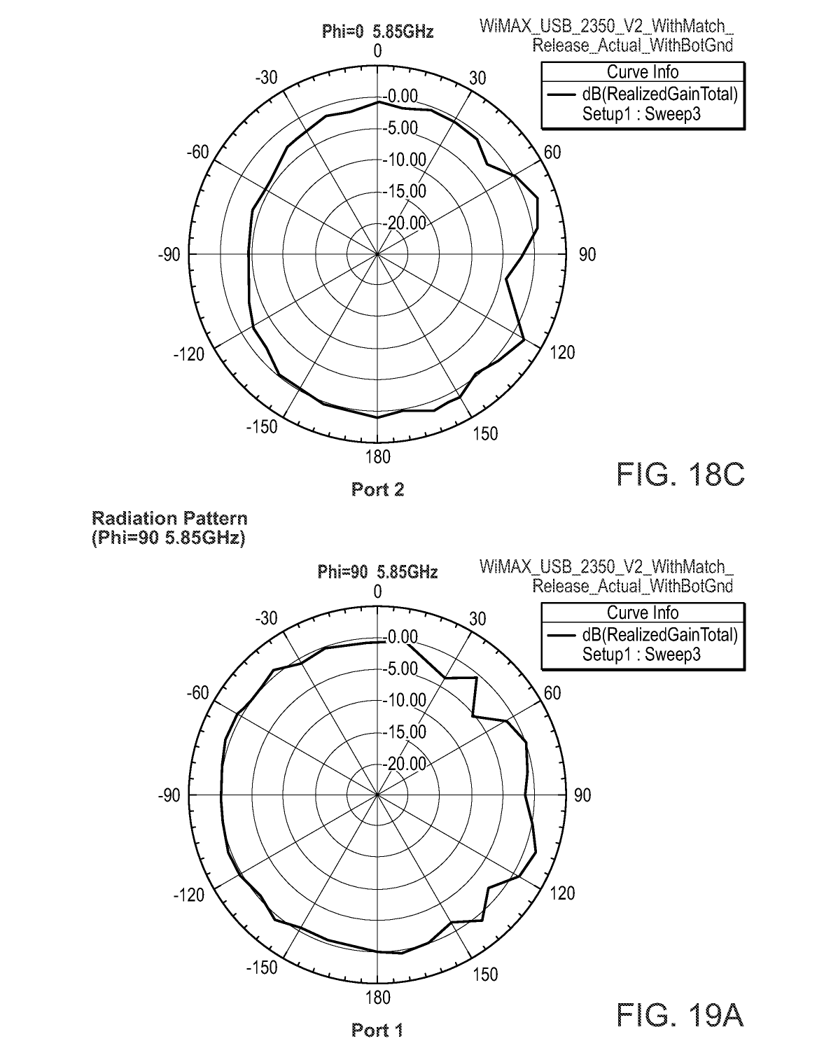

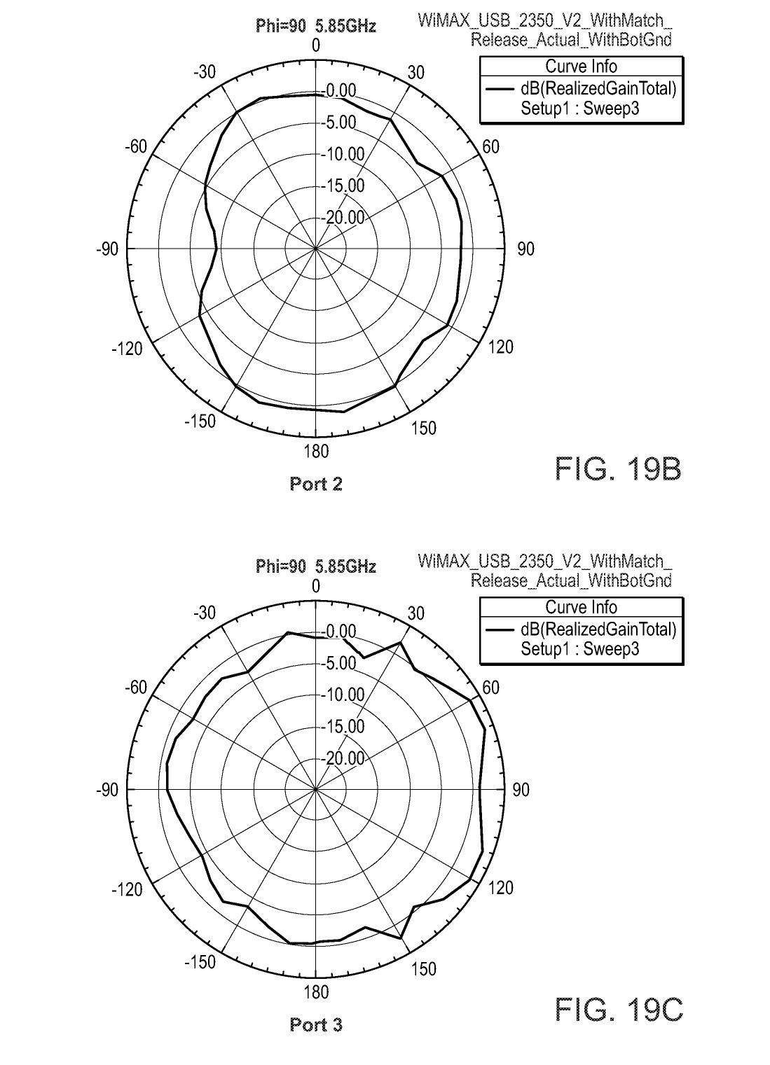

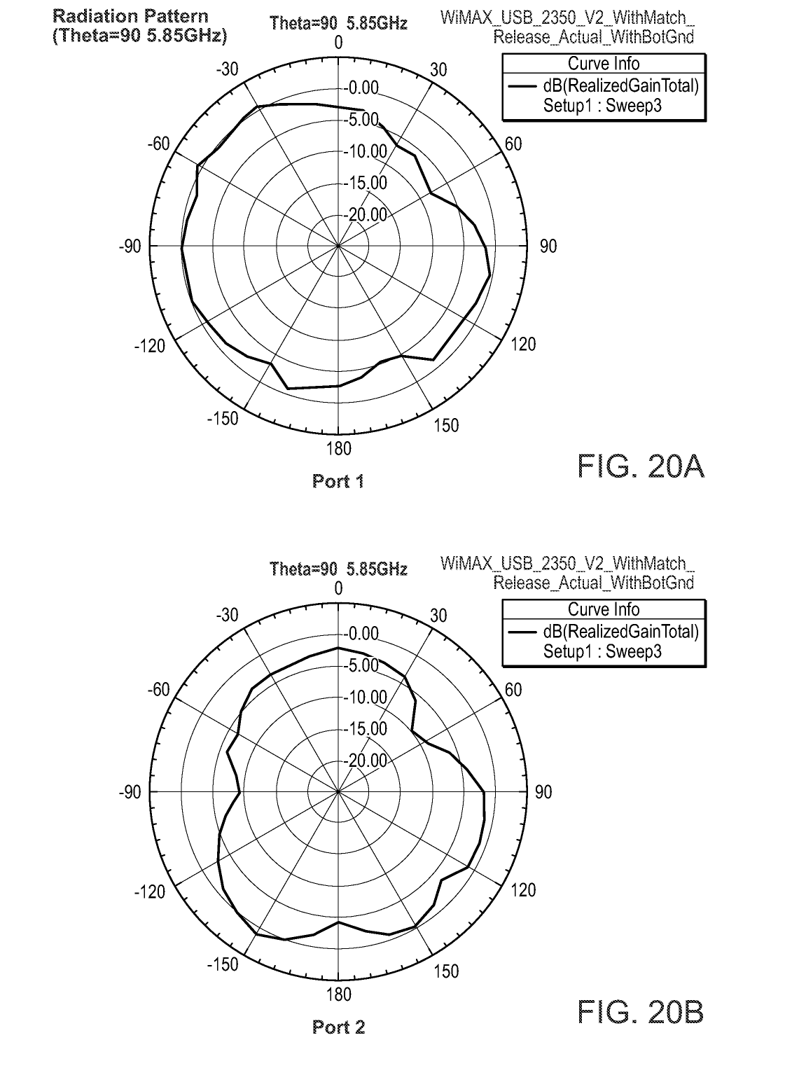

It can be seen from FIGS. 4, 5 and 6 that isolation between the end feedports 108, 110 is achieved even though they are connected via the two interconnecting elements 114, 116. (In the figures, “Port 1”, “Port 2”, and “Port 3” refer to the feedports 110, 112, and 108, respectively.) Since the current is cancelled at the common (center) feedport 112 at the resonance condition when either end port 108, 110 is excited, little current flows from the interconnecting element from the center radiating antenna section 106 to either opposite end antenna section 102, 104. Additionally, the center radiating section 106 has little or no induced current over the frequency range according to the principles described above (paragraphs [0018] and [0019]); it acts therefore as a shield to induced currents over that frequency range for the distal antenna section. Therefore little signal is coupled to the distal antenna section and its associated feedport.

The antenna structure 100 can be manufactured using various processes from a variety of electrically conductive materials. For instance, the antenna can be manufactured by metal stamping sheet-metal, e.g., a copper alloy sheet. Alternately, it can be fabricated as a flexible or hard printed circuit made, e.g., from copper, and mounted on a carrier.

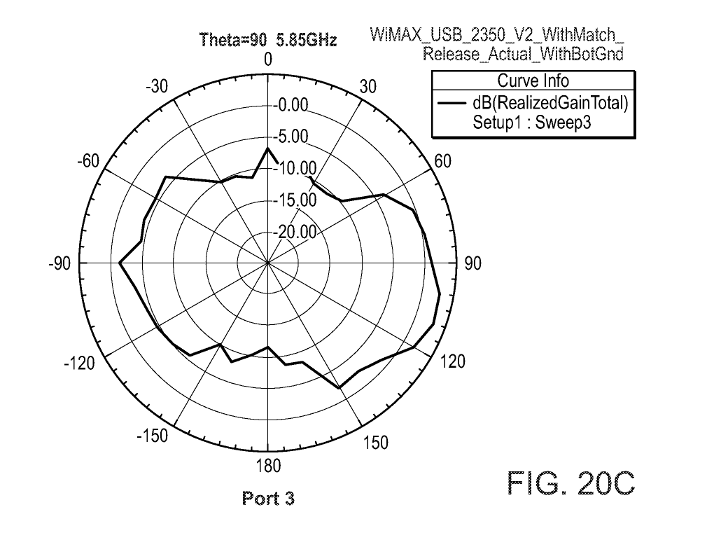

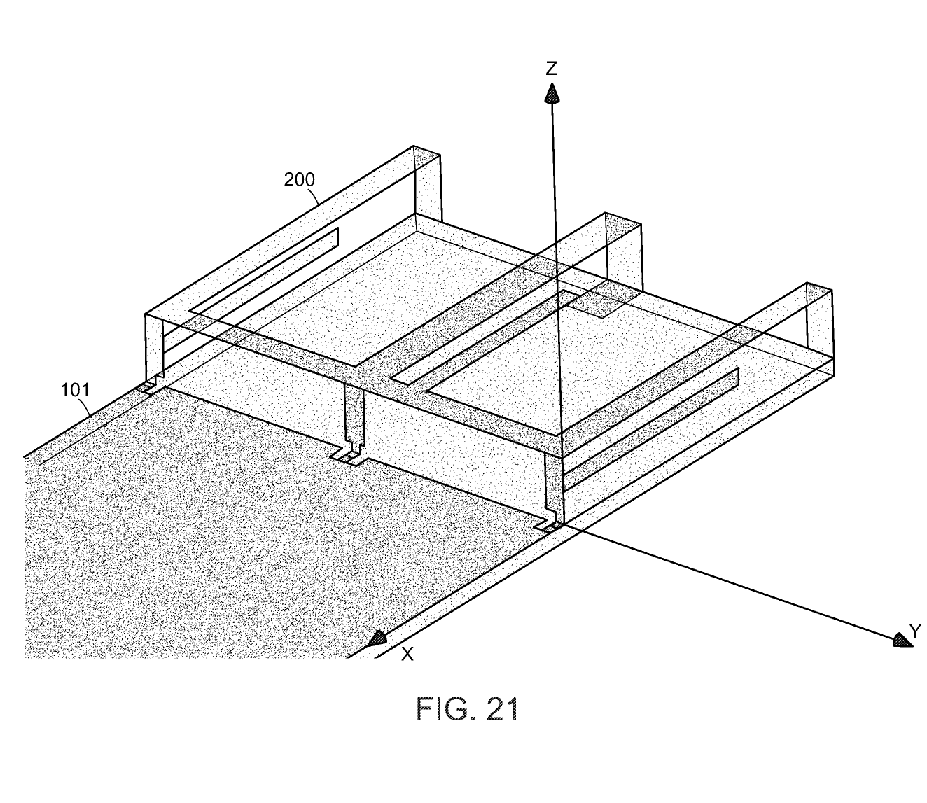

FIG. 21 illustrates an alternative antenna structure 200 in accordance with one or more embodiments. The antenna 200 is particularly configured for use in a USB dongle for providing wireless connectivity.

While examples above illustrate an antenna with three electrically conductive elements and three antenna ports, it should be understood that an antenna embodying the features described herein can include any number of electrically conductive elements and antenna ports. In particular, in accordance with some embodiments, antennas with more than three electrically conductive elements and antenna ports can be used.

It is to be understood that the disclosure describes particular embodiments, which are provided as illustrative only, and do not limit or define the scope of the invention. Various other embodiments, including but not limited to the following, are also within the scope of the claims. For example, elements and components described herein may be further divided into additional components or joined together to form fewer components for performing the same or similar functions.

What is claimed is:

1. A multi-feed, low-profile antenna structure with high port-to-port isolation and multiband operation, comprising:
three electrically conductive antenna sections arranged in a generally linear configuration, including a first antenna section, a second antenna section, and a common antenna section therebetween;
three feedports, each connected to a different one of the three antenna sections; and
a first electrically conductive interconnecting element connecting the first antenna section to the common antenna section, and a second electrically conductive interconnecting element connecting the second antenna section to the common antenna section, such that each feedport is generally electrically isolated from other feedports;
wherein the antenna sections and interconnecting elements form a single, substantially planar radiating structure.

2. The antenna structure of claim 1, wherein the antenna structure is configured for 3×3 MIMO or diversity applications.

3. The antenna structure of claim 1, wherein the antenna structure is configured for use in a notebook computer, a netbook computer, a tablet computer, or a set-top box.

4. The antenna structure of claim 1, wherein each antenna section comprises two branches, each optimized for operation within a given frequency band.

5. The antenna structure of claim 1, wherein each antenna section comprises two branches, one of said branches being optimized for operation within a 5 GHz frequency band, and the other of said branches being optimized for operation within a 2.4 GHz frequency band.

6. The antenna structure of claim 1, wherein the antenna structure comprises a stamped metal part.

7. The antenna structure of claim 1, wherein the antenna structure comprises a flexible printed circuit mounted on a plastic carrier.

8. The antenna structure of claim 1, wherein the antenna structure comprises a printed circuit.

9. The antenna structure of claim 8, wherein the printed circuit is hard or flexible.

10. The antenna structure of claim 1, wherein the distance between the first and second antenna sections is generally twice the distance between the first antenna section and the common antenna section.
